(19) United States
(12) Patent Application Publication
(10) Pub. No.: US 2026/0364832 A1
(43) Pub. Date: Nov. 19, 2026

(54) SELF-CLEANING MAGNETIC LEVITATION SHAVER

(71) Applicant: Miban (Shanghai) Technology Co., Ltd., Shanghai (CN)

(72) Inventor: Fanwei Kong, Dalian City (CN)

(21) Appl. No.: 19/559,982

(22) Filed: Mar. 7, 2026

(30) Foreign Application Priority Data
May 15, 2025 (CN) 2025106311873
Oct. 14, 2025 (CN) 2025221760003
Nov. 17, 2025 (CN) 2025224374931

(51) Int. Cl. B26B 19/14; B26B 19/28; B26B 19/38

(52) U.S. Cl. CPC B26B 19/145; B26B 19/28; B26B 19/382

(57) ABSTRACT

Provided is a self-cleaning magnetic levitation shaver. During cleaning, a drive assembly generates an alternating magnetic field which penetrates through a drive base and a cutter head base and is magnetically coupled with a cutter head assembly. The cutter head assembly rotates under an action of the alternating magnetic field to drive a negative pressure generation component arranged on the cutter head assembly to rotate synchronously. When the negative pressure generation component rotates, a low-pressure zone is formed inside or around the cutter head assembly. The low-pressure zone draws external water or a cleaning solution into an accommodating cavity inside the cutter head base through physical suction. A liquid drawn into the accommodating cavity forms a specific flow path to clean hair debris from a surface and gaps of the cutter head assembly. Finally, wastewater is discharged through a discharge hole pre-formed on the cutter head base.

### TECHNICAL FIELD

The present disclosure relates to the technical field of shavers, and specifically relates to a self-cleaning magnetic levitation shaver.

### BACKGROUND

The main function of a shaver is to remove hairs from the face or body, making the skin smooth and neat. Traditional shavers are easy to scratch or cut the skin during shaving and require a long shaving time. Moreover, electric shavers are favored by many users due to convenient operations and short operation duration.

Electric shavers are typically powered by a motor. The motor drives a cutter head to rotate to enable a shaving action of the cutter head. However, during a disassembly and cleaning process, the entire cutter head needs to be removed for cleaning. Currently, the cleaning of electric shavers is faced with the following drawbacks:
1. A disassembly and reassembly process is challenging. During the disassembly process, all components inside a cutter head must be removed for cleaning, resulting in a significantly prolonged disassembly and reassembly process.
2. The cleaning effect is often insufficient. Electric shavers are powered by a motor and a drive assembly (including a drive shaft and a drive gear). The drive assembly is fixed to the main body and thus cannot be removed during disassembly. Additionally, there are gaps between the drive assembly and a shaver head. Once entering the gaps, beard hairs are difficult to clean. If an electric shaver is rinsed directly with water, the water may seep into the interior to damage the drive assembly.
3. Existing magnetic induction-based drive structures adopt an open-loop magnetic drive mode, resulting in low effective magnetic flux utilization efficiency of a magnetic field and suboptimal shaving performance of a cutter head.
4. The existing outer foil is fixed to a housing and thus cannot move relative to the housing. As a result, the outer foil cannot actively capture beard hairs, and the probability for beard hairs to enter the outer foil is low, leading to low shaving efficiency.

### SUMMARY

The present disclosure provides a self-cleaning magnetic levitation shaver to address the aforementioned technical issues.

To achieve the above purpose, the present disclosure provides a self-cleaning magnetic levitation shaver, including:
a drive base inside which a sealed cavity is formed;
a drive assembly arranged in the sealed cavity;
a cutter head base inside which an accommodating cavity is formed, where the cutter head base is provided with a discharge hole communicating with the accommodating cavity;
a cutter head assembly that is arranged in the accommodating cavity and partially extends out of the accommodating cavity, where the cutter head assembly communicates with the accommodating cavity; and
a negative pressure generation component arranged on the cutter head assembly,
where when the drive assembly operates, a magnetic field is generated and coupled with the cutter head assembly to drive the cutter head assembly to move to drive a rotation of the negative pressure generation component, whereby a negative pressure is generated to draw external water into the accommodating cavity for cleaning.

Preferably, the self-cleaning magnetic levitation shaver further includes:
a division plate that is arranged in the accommodating cavity and divides the accommodating cavity into a negative pressure chamber and a cleaning chamber, where the division plate is provided with a via hole, the negative pressure chamber communicates with the cleaning chamber through the via hole, and the negative pressure chamber communicates with the discharge hole;
the cutter head assembly has an end arranged inside the negative pressure chamber and another end extending through the division plate into the cleaning chamber;
the negative pressure generation component is located inside the negative pressure chamber and is arranged surrounding the cutter head assembly; and
when the negative pressure generation component rotates, the negative pressure is generated inside the negative pressure chamber to induce a vortex flow of a cleaning solution in the cleaning chamber to clean the cutter head assembly inside the cleaning chamber.

Preferably, the self-cleaning magnetic levitation shaver further includes:
an annular component arranged inside the negative pressure chamber, where the annular component, the division plate, and a bottom wall of the accommodating cavity enclose a negative pressure generation chamber and a drainage channel, the annular component is provided with a through hole, and the negative pressure generation chamber communicates with the discharge hole through the through hole and the drainage channel.

Preferably, the cutter head assembly includes:
a first magnetic yoke arranged in the negative pressure generation chamber, where the negative pressure generation component is arranged surrounding an outer peripheral surface of the first magnetic yoke;
a magnetic component arranged on a side of the first magnetic yoke that is close to the drive assembly, where the magnetic component is coupled with the drive assembly; and
a magnetic permeable component arranged on a side of the magnetic component that is close to the drive assembly, where the magnetic permeable component and the first magnetic yoke enclose a sealing chamber, and the magnetic component is located in the sealing chamber.

Preferably, the cutter head assembly further includes:
a driving shaft, where an end of the driving shaft is rotatably connected to the cutter head base and is located in the negative pressure generation chamber, and another end of the driving shaft passes through the magnetic permeable component, the sealing chamber, and the division plate sequentially and extends into the cleaning chamber;
a drive gear that is arranged on the driving shaft and is located in the cleaning chamber;
a connecting gear set that is arranged in the cleaning chamber and meshes with the drive gear; and
a cutting unit that is arranged in the cleaning chamber and is rotatably connected to the connecting gear set.

Preferably, the cutter head assembly further includes:
a mounting frame fixed in the cleaning chamber, where both the driving shaft and the connecting gear set are rotatably connected to the mounting frame.

Preferably, the drive assembly includes:
a mounting shell arranged in the sealed cavity, where the mounting shell is provided with a receiving cavity; and
an induction coil that is arranged in the receiving cavity and is coupled with the magnetic component.

Preferably, a side of the drive base that is close to the cutter head base has a first magnetic permeable surface;
a side of the cutter head base that is close to the drive base has a second magnetic permeable surface; and
a magnetic field of the induction coil penetrates through the first magnetic permeable surface, the second magnetic permeable surface, and the magnetic permeable component and is coupled with the magnetic component.

Preferably, the drive assembly further includes:
a second magnetic yoke arranged in the receiving cavity, where the second magnetic yoke is located on a side of the induction coil that is away from the cutter head assembly.

Preferably, the drive assembly further includes:
a circuit board, disposed within the sealed cavity;
a power supply, disposed within the sealed cavity, where the circuit board is electrically connected to the induction coil and the power supply.

Preferably, the self-cleaning magnetic levitation shaver includes:
the cutter head assembly; and
the drive assembly, where the drive assembly includes a drive magnetic component, a magnetic field variation component, and an auxiliary magnetic component; the drive magnetic component is in transmission connection with the cutter head assembly, the magnetic field variation component is located between the auxiliary magnetic component and the drive magnetic component, and the auxiliary magnetic component and the drive magnetic component are symmetrically arranged relative to the magnetic field variation component; and the magnetic field variation component is coupled with both the auxiliary magnetic component and the drive magnetic component; and
a concentrating assembly in which an accommodating space is formed, where the drive assembly is arranged in the accommodating space, and
the concentrating assembly is configured to concentrate magnetic fields of the drive magnetic component, the magnetic field variation component, and the auxiliary magnetic component within the accommodating space.

Preferably, the concentrating assembly includes:
a first shielding component, where a side of the first shielding component that is close to the auxiliary magnetic component is provided with a first accommodating groove and the drive magnetic component is arranged in the first accommodating groove; and
a second shielding component, where a side of the second shielding component that is close to the drive magnetic component is provided with a second accommodating groove, the auxiliary magnetic component is arranged in the second accommodating groove, and the magnetic field variation component is located between the first shielding component and the second shielding component.

Preferably, the self-cleaning magnetic levitation shaver includes:
the cutter head base inside which a mounting cavity is formed;
an outer foil provided on the cutter head base;
a cutting assembly that is arranged inside the mounting cavity and partially extends into the outer foil; and
an auxiliary reciprocating assembly that is arranged on the outer foil and is in transmission connection with the cutting assembly,
where when the cutting assembly is driven, the outer foil is driven through the auxiliary reciprocating assembly to perform a bidirectional reciprocating oscillation relative to the cutter head base.

Preferably, the auxiliary reciprocating assembly includes:
a first reciprocating component, where the first reciprocating component is provided with a movement groove, an end of the first reciprocating component is detachably connected to the outer foil, and the first reciprocating component is provided with a rotation hole; and
a fixation component provided with a rotating column, where the rotating column passes through the rotation hole and the first reciprocating component is rotatably connected to the fixation component; and
the cutting assembly includes:
a drive shaft that is arranged inside the cutter head base and passes through the fixation component; and
an eccentric wheel that is eccentrically arranged on the drive shaft and extends into the movement groove,
where when the drive shaft rotates, the first reciprocating component is driven through the eccentric wheel to perform a reciprocating oscillation around the rotating column as an axis, so as to drive the outer foil to perform a reciprocating oscillation relative to the cutter head base.

The self-cleaning magnetic levitation shaver provided in the present disclosure has the following beneficial effects:
1. In the self-cleaning magnetic levitation shaver provided in the present disclosure, an alternating magnetic field is generated by a drive assembly to drive a cutter head assembly to operate. A negative pressure generation component rotates synchronously with the cutter head assembly to create a low-pressure zone inside or around the cutter head assembly. Through adsorption, the hair debris is effectively cleaned from the surface and gaps of the cutter head assembly. When cleaning is conducted with water, water is drawn and flows along pre-formed channels through a negative pressure to carry away hairs and stains, thereby completing a cleaning process. The drive assembly and the cutter head assembly are completely isolated physically. Consequently, cleaning can be completed without disassembling a shaver, thereby enhancing user convenience.
2. In the self-cleaning magnetic levitation shaver provided in the present disclosure, when the drive assembly operates, an internal induction coil generates an alternating magnetic field. A part of the alternating magnetic field directly penetrates through a magnetic permeable component to drive a magnetic component to move. Through actions of a first magnetic yoke and a second magnetic yoke, a magnetic flux loops back to create a superposition effect with a forward magnetic field, which can effectively enhance the working efficiency of magnetic drive.
3. An auxiliary reciprocating assembly is provided in a cutter head of the self-cleaning magnetic levitation shaver. Consequently, when the self-cleaning magnetic levitation shaver operates, the cutter head actively performs a subtle reciprocating movement under an action of the auxiliary reciprocating assembly, which further improves the hair-capturing efficiency of the shaver head and optimizes the shaving results.

### BRIEF DESCRIPTION OF THE DRAWINGS

FIG. 1 is a schematic structural diagram of the self-cleaning magnetic levitation shaver in the present disclosure;

FIG. 2 is an exploded view of the self-cleaning magnetic levitation shaver in the present disclosure;

FIG. 3 is a partial exploded view of the self-cleaning magnetic levitation shaver in the present disclosure;

FIG. 4 is a cross-sectional view of the self-cleaning magnetic levitation shaver in the present disclosure;

FIG. 5 is a partial structural diagram of the self-cleaning magnetic levitation shaver in the present disclosure;

FIG. 6 is a cross-sectional view of FIG. 5;

FIG. 7 is a cross-sectional view of a partial structure in FIG. 3;

FIG. 8 is an exploded view of a partial structure of a cutter head assembly;

FIG. 9 is a structural diagram of a partial structure in FIG. 6;

FIG. 10 is an exploded view of a shaver with a magnetic focusing structure in the present disclosure;

FIG. 11 is a first partial exploded view of the magnetic focusing structure in FIG. 10;

FIG. 12 is a second partial exploded view of the magnetic focusing structure in FIG. 10;

FIG. 13 is a structural diagram of an outer foil and an auxiliary reciprocating assembly that are assembled in the present disclosure;

FIG. 14 is an exploded view of the outer foil and the auxiliary reciprocating assembly that are assembled in FIG. 13;

FIG. 15 is a schematic diagram of the auxiliary reciprocating assembly in FIG. 13 (where B indicates a movement direction of an eccentric wheel and A indicates a movement direction of a first reciprocating component);

FIG. 16 is a cross-sectional view of a self-cleaning magnetic levitation shaver undergoing magnetic attraction optimization in the present disclosure;

FIG. 17 is a structural diagram of the self-cleaning magnetic levitation shaver undergoing magnetic attraction optimization in the present disclosure;

FIG. 18 is a structural diagram of FIG. 17 with a cutter head assembly and an auxiliary reciprocating assembly removed;

FIG. 19 is a structural diagram of a magnetic field variation component, a second shielding component, and a second magnet;

FIG. 20 is a schematic diagram of a partial structure inside a cutter head base in FIG. 17;

FIG. 21 is a schematic diagram of the partial structure in FIG. 20;

FIG. 22 is an internal structural diagram of a lower housing in FIG. 17;

FIG. 23 is a schematic structural diagram of a cutter head base and a negative pressure generation component in FIG. 17; and

FIG. 24 is a schematic structural diagram of the lower housing and an induction coil in FIG. 17.

### REFERENCE NUMERALS

100. self-cleaning magnetic levitation shaver; 110. drive base; 110a. sealed cavity; 111. first magnetic permeable surface; 120. drive assembly; 121. mounting shell; 121a. receiving cavity; 122. induction coil; 123. second magnetic yoke; 125. power supply; 130. cutter head base; 130a. accommodating cavity; 130b. discharge hole; 131. second magnetic permeable surface; 140. cutter head assembly; 141. first magnetic yoke; 142. magnetic component; 143. magnetic permeable component; 143a. sealing chamber; 144. driving shaft; 145. drive gear; 146. connecting gear set; 147. cutting unit; 148. mounting frame; 150. negative pressure generation component; 160. division plate; 160a. negative pressure chamber; 160b. cleaning chamber; 160c. via hole; 170. annular component; 170a. negative pressure generation chamber; 170b. drainage channel; 170c. through hole; 180. circuit board; a110. cutter head assembly; a121. drive magnetic component; a122. magnetic field variation component; a123. auxiliary magnetic component; a130a. accommodating space; a131. first shielding component; a131a. first accommodating groove; a132. second shielding component; a132a. second accommodating groove; b110. cutter head base; b110a. mounting cavity; b120. outer foil; b130. cutting assembly; b131. drive shaft; b132. eccentric wheel; b1301. cutter head; b1322. motor; b140. auxiliary reciprocating assembly; b141a. movement groove; b147. first reciprocating component; b147a. rotation hole; b148. fixation component; b1481. rotating column; c110. lower housing; c120. first magnet; and c130. second magnet.

The implementation of the objective, the functional characteristics, and the advantages of the present disclosure will be further described below with reference to the embodiments and accompanying drawing.

### DETAILED DESCRIPTION OF THE EMBODIMENTS

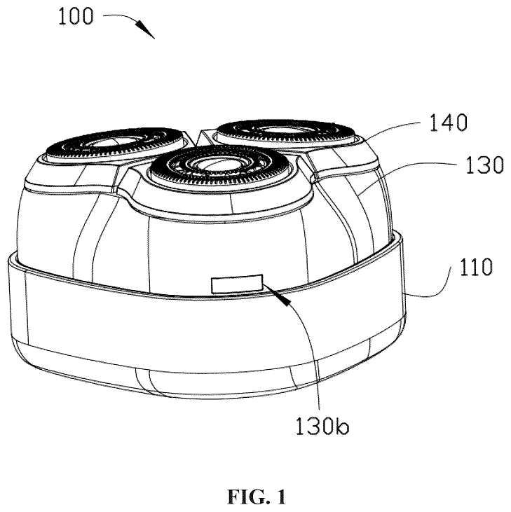

Embodiment 1: As shown in FIG. 1, in this embodiment, a self-cleaning magnetic levitation shaver 100 includes a cutter head assembly 140, a cutter head base 130, and a drive base 110. A side bottom surface of the cutter head base 130 is provided with a discharge hole 130b.

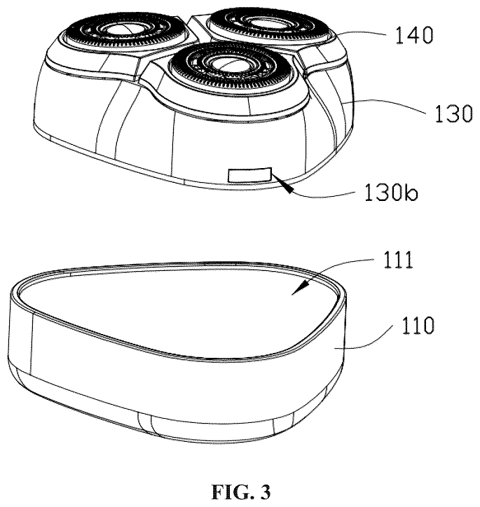

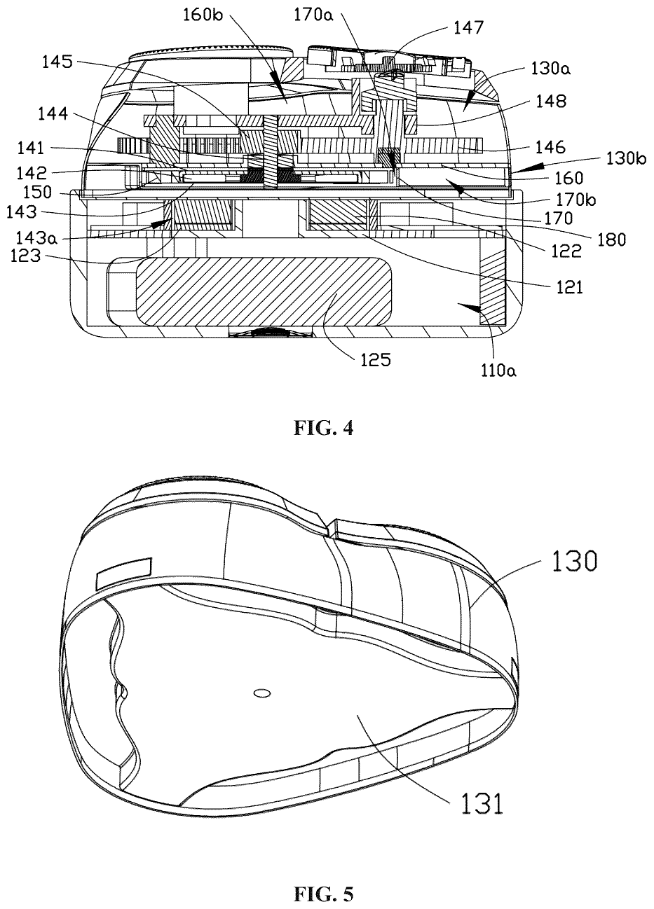

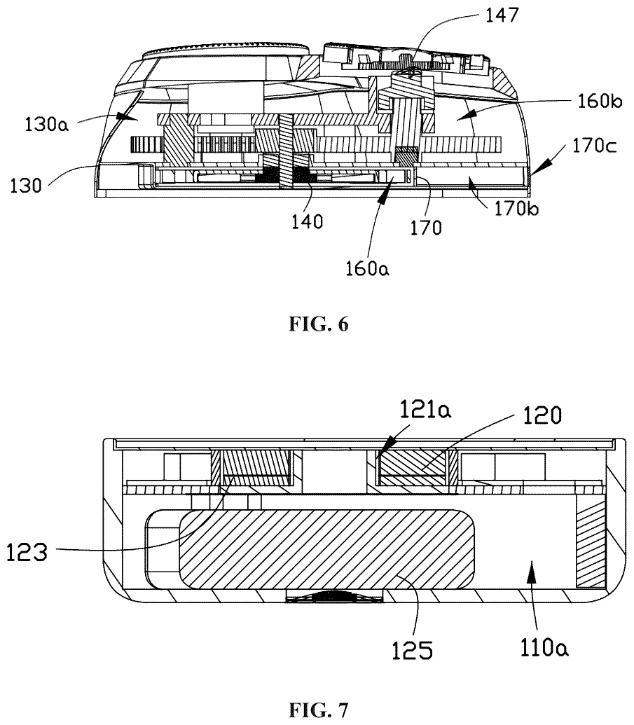

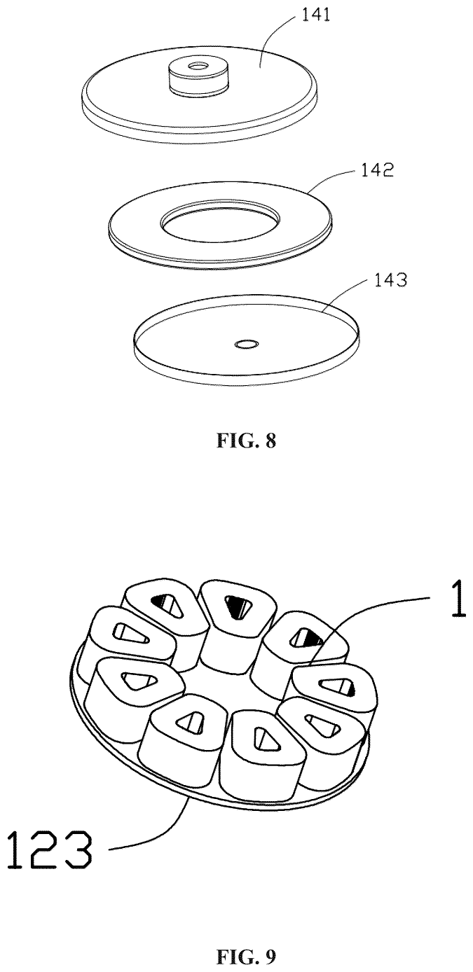

As shown in FIG. 1 to FIG. 9, in this embodiment, during cleaning, a drive assembly 120 generates an alternating magnetic field. The alternating magnetic field generated by the drive assembly 120 penetrates through the drive base 110 and the cutter head base 130, and is magnetically coupled with the cutter head assembly 140, thereby achieving contactless drive.

The cutter head assembly 140 rotates under an action of the alternating magnetic field to drive a negative pressure generation component 150 arranged on the cutter head assembly to rotate synchronously.

When the negative pressure generation component 150 rotates, a low-pressure zone is formed inside or around the cutter head assembly 140. The low-pressure zone draws external water or a cleaning solution into an accommodating cavity 130a inside the cutter head base 130 through physical suction. A liquid drawn into the accommodating cavity 130a forms a specific flow path (such as a vortex or flush flow) to clean hair debris from a surface and gaps of the cutter head assembly 140.

Finally, wastewater is discharged through the discharge hole 130b pre-formed on the cutter head base 130. In this way, a cleaning process is completed.

Through magnetic drive and a negative pressure water-drawing structure, cleaning can be completed without disassembling a shaver, thereby enhancing user convenience. The drive assembly 120 and the cutter head assembly 140 are completely isolated physically, and are coupled through a magnetic field. The drive portion is sealed in a sealed cavity 110a, which can effectively prevent water from entering the drive assembly 120.

A water flow drawn in can enter gaps between the cutter head assembly 140 and the accommodating cavity 130a. Under an action of the negative pressure generation component 150, a cleaning solution forms a vortex flow in the accommodating cavity 130a to clean residual hairs and skin flakes that are typically difficult to remove.

After the self-cleaning magnetic levitation shaver 100 is activated, the drive assembly 120 is energized and begins to generate a magnetic field. The cutter head assembly 140 is located within an action zone of the alternating magnetic field of the drive assembly 120. The alternating magnetic field generated by the drive assembly 120 is electromagnetically coupled with the cutter head assembly 140. Under a magnetic field variation, the cutter head assembly 140 rotates to achieve the cutting of beard or hair.

When the self-cleaning magnetic levitation shaver 100 is turned off, the drive assembly 120 is de-energized, the alternating magnetic field disappears, and the cutter head assembly 140 is no longer attracted. In this case, there is no magnetic attraction between the cutter head base 130 and the drive base 110, and a user can easily remove the cutter head base 130 for cleaning or replacement.

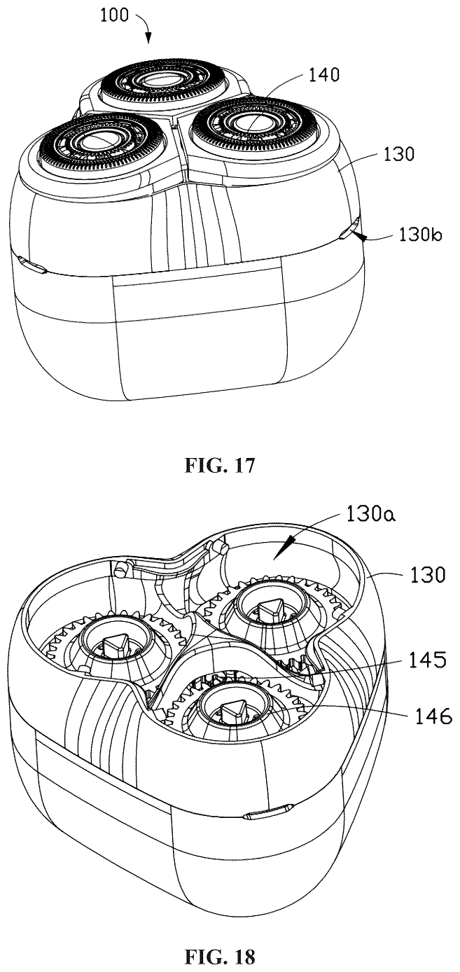

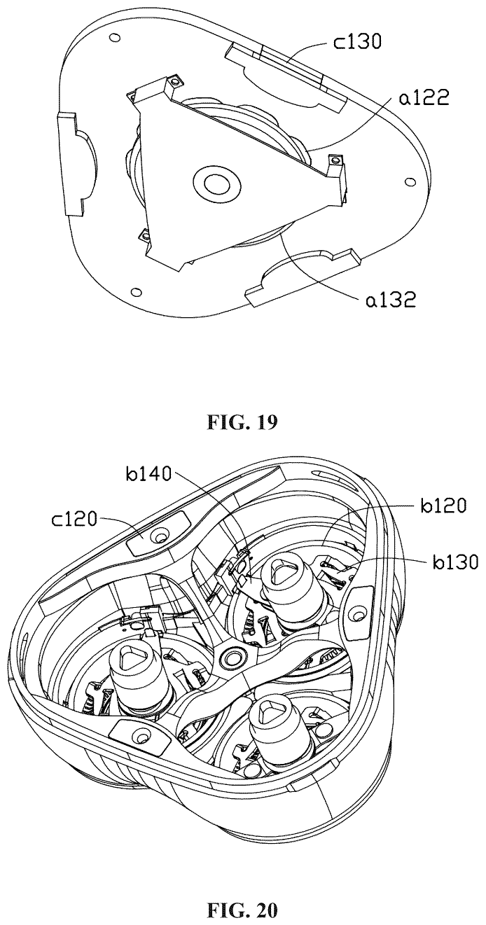

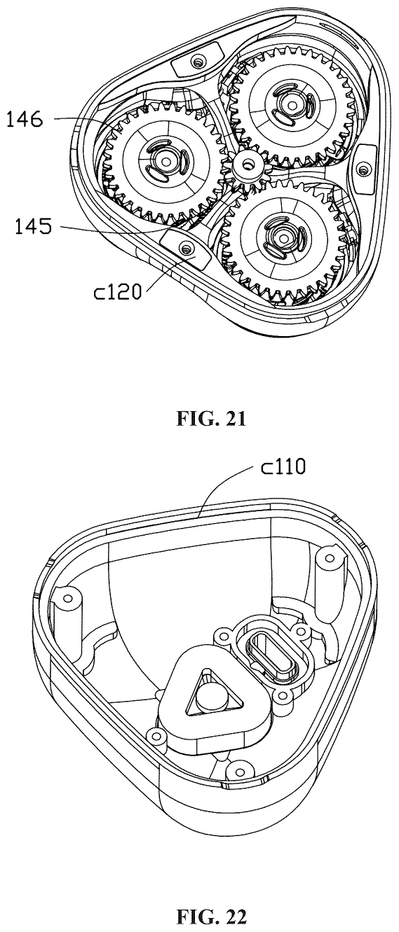

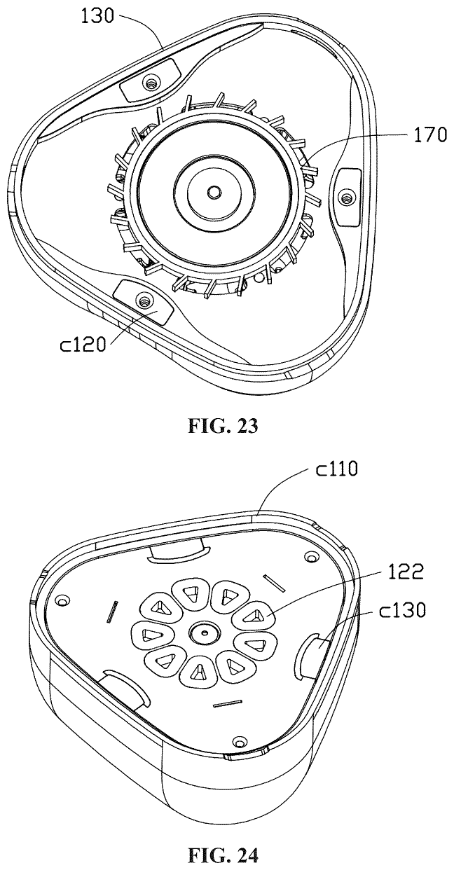

In other embodiments, FIG. 16 to FIG. 24 are referred to accordingly. To prevent the cutter head base 130 from detaching from a lower housing c110 due to the failed generation of a magnetic field by the magnetic drive coil when the self-cleaning magnetic levitation shaver 100 is not in use, a first magnet c120 is provided at a position on the cutter head base 130 that is close to the lower housing c110, and a second magnet c130 is provided at a position on the lower housing c110 that is close to the cutter head base 130. Through the attraction between the first magnet c120 and the second magnet c130, the cutter head base 130 remains attracted to the lower housing c110 when the self-cleaning magnetic levitation shaver is not in use, which prevents the detachment of the cutter head base 130 from the lower housing c110.

It should be noted that three sets the first magnet c120 and the second magnet c130 are provided. In other embodiments, one or more sets of the first magnet and the second magnet may be provided.

The entire drive structure includes the drive assembly 120 and the cutter head assembly 140, and does not require the traditional motor. Consequently, the overall structure is compact and significantly miniaturized.

It should be noted that the drive base 110 is approximately in a triangular prism shape. In other embodiments, the drive base may be in other shapes. The discharge hole 130b is approximately a rectangular through hole. The sealed cavity 110a is an internal space of the drive base 110. The cutter head base 130 and the drive base 110 have roughly the same shape, and the accommodating cavity 130a is a semi-sealed cavity.

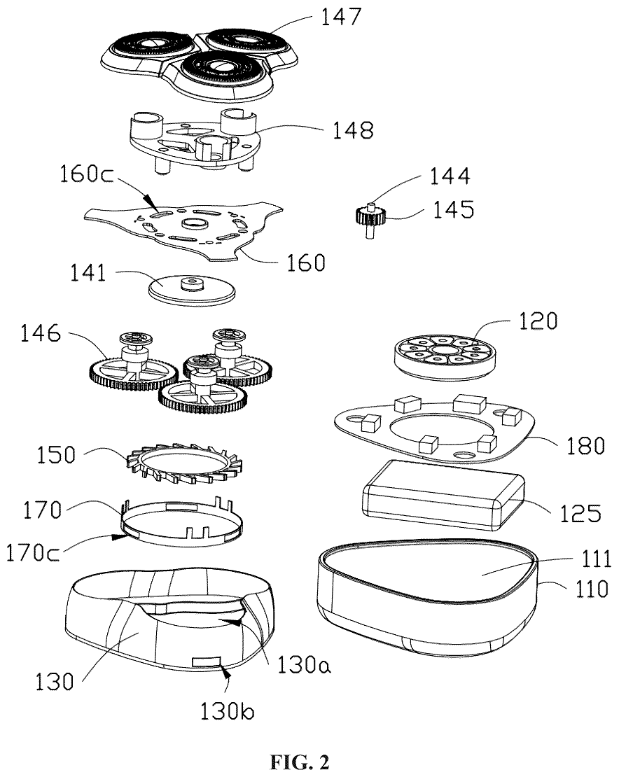

As shown in FIG. 2 to FIG. 4, in this embodiment, a division plate 160 is provided inside the cutter head base 130 to divide the accommodating cavity 130a into a negative pressure chamber 160a and a cleaning chamber 160b. The negative pressure chamber 160a is configured to generate and maintain negative pressure suction. The cleaning chamber 160b is configured to accommodate the cutter head assembly 140 and allow a cleaning process.

The division plate 160 is generally plate-shaped. In this embodiment, the division plate is approximately triangular. In other embodiments, the division plate may be in other shapes. The division plate 160 is provided with a via hole 160c, such that a controlled flow path can be formed between the negative pressure chamber 160a and the cleaning chamber 160b. The via hole 160c is a through hole.

The negative pressure generation component 150 is an impeller. The negative pressure generation component 150 is arranged in the negative pressure chamber 160a and surrounds an exterior of the cutter head assembly 140. The negative pressure generation component 150 includes a ring portion and a blade portion arranged on the ring portion. The ring portion is configured to sleeve around a peripheral wall of the cutter head assembly 140.

The accommodating cavity 130a is rationally partitioned into the negative pressure chamber 160a to generate a negative pressure and the cleaning chamber 160b to clean a cutter head region, thereby preventing interference.

A liquid flows concentrically within the cleaning chamber 160b, making the rinsing thorough.

Through the via hole 160c, directional flow guidance can be provided to enable a stable vortex flow of a cleaning solution in the cleaning chamber 160b.

The vortex flow allows a strong impact on the surface and gaps of the cutter head assembly 140, which can enhance a cleaning effect.

The negative pressure chamber 160a is isolated from the drive assembly 120 to enhance the leak tightness among component structures.

It should be noted that, when the drive assembly 120 drives the cutter head assembly 140 to move, the cutter head assembly 140 and the negative pressure generation component 150 together constitute a water pump structure. When a liquid enters the accommodating cavity 130a and comes into contact with the negative pressure generation component 150, the negative pressure generation component 150 acts as a water pump to generate a negative pressure effect. Under a combined action of the negative pressure generation component 150 and the cutter head assembly 140, a liquid in the cleaning chamber 160b forms a vortex flow to rinse the surface and gaps of the cutter head assembly 140.

As shown in FIG. 1 to FIG. 9, in this embodiment, an annular component 170 partially encloses the negative pressure chamber 160a independently to form a negative pressure generation chamber 170a. A water flow drawn by the negative pressure generation component 150 is concentrated within the negative pressure generation chamber 170a to enhance negative pressure suction of the water flow.

The annular component 170 is provided with a through hole 170c. The negative pressure generation chamber 170a can communicate with a drainage channel 170b through the through hole 170c. A suction force generated by a negative pressure can draw a cleaning solution through these paths while discharging a waste liquid.

A cleaning solution enters the cleaning chamber 160b from an external environment under a negative pressure, flows into the negative pressure chamber 160a under an action of the negative pressure generation component 150, and then flows through the negative pressure generation chamber 170a, the through hole 170c, the drainage channel 170b, and the discharge hole 130b to an external environment.

By forming the negative pressure generation chamber 170a with the annular component 170, a negative pressure can be concentrated in a designated space to increase a negative pressure formation speed and a suction strength during a cleaning process.

The annular component 170, the division plate 160, and a bottom wall of the accommodating cavity 130a constitute a defined flow-guiding structure, which can prevent a cleaning solution from flowing disorderly or stagnating within a chamber.

A waste liquid can be effectively guided to quickly enter the drainage channel 170b to reduce residue and secondary contamination, which improves operational stability and cleaning efficiency.

The annular component 170, as a structural isolation component, can restrict a flow path of a cleaning solution to prevent the cleaning solution from flowing backward into the cleaning chamber 160b, which ensures that the cutter head assembly 140 is not subjected to secondary contamination.

As shown in FIG. 1 to FIG. 9, in this embodiment, the negative pressure generation component 150 is arranged surrounding an outer peripheral surface of a first magnetic yoke 141. When the first magnetic yoke 141 rotates under a magnetic force, the negative pressure generation component 150 is driven to rotate synchronously. During cleaning, a cleaning solution flows through the negative pressure generation component 150 to form a water pump structure, such that the cleaning solution inside the cleaning chamber 160b forms a vortex flow to clean the cutter head assembly 140.

A magnetic component 142 is fully enclosed within a sealing chamber 143a formed by the first magnetic yoke 141 and a magnetic permeable component 143 to prevent a cleaning solution from entering an electromagnetic induction region.

The first magnetic yoke 141, the magnetic component 142, and the magnetic permeable component 143 constitute an efficient magnetic circuit to improve energy utilization efficiency and reduce energy consumption while achieving a compact and rational structure.

The negative pressure generation component 150 is arranged surrounding the first magnetic yoke 141 to enable a stable and uniform rotational power. During cleaning, this design can guarantee continuous and stable negative pressure suction, thereby improving the suction efficiency and rinsing effect of a blade cleaning solution.

When the drive assembly 120 operates, an internal induction coil 122 generates an alternating magnetic field. A part of the alternating magnetic field directly penetrates through the magnetic permeable component 143 to drive the magnetic component 142 to move.

Another part of the alternating magnetic field is redirected by the first magnetic yoke 141 to act on the magnetic component 142. These two parts of the magnetic field are superimposed at the magnetic component 142 to allow a strong magnetic response torque, which enhances the response sensitivity of the magnetic component 142, reduces the power wastage caused by magnetic leakage losses, and contributes to drive power consumption reduction and energy utilization efficiency enhancement.

The combination of the first magnetic yoke 141 and the magnetic component 142 provides an efficient magnetic drive system to ensure that the entire negative pressure rotation system operates smoothly with small noise and minimal vibration, which facilitates the continuous and stable inflow of a cleaning solution.

The magnetic component 142 is located on a side of the first magnetic yoke 141 that is close to the drive assembly 120. The magnetic component 142 is a ring-shaped magnet. In other embodiments, the magnetic component may be an array or a ring-shaped arrangement of rectangular magnets. The magnetic component includes, but is not limited to the aforementioned arrangements and shapes, and a multi-pole magnet may also be employed.

The first magnetic yoke 141 is made of a high-magnetic-permeability material, and is configured to form a closed magnetic circuit to improve magnetic flux utilization efficiency. For example, the high-magnetic-permeability material is a silicon steel material or a soft magnetic iron alloy material. The first magnetic yoke 141 is located on a side of the magnetic component 142 that is away from the drive assembly 120. The magnetic permeable component 143 is generally disc-shaped.

As shown in FIG. 1 to FIG. 9, in this embodiment, an end of a driving shaft 144 is arranged in the negative pressure generation chamber 170a and is fixedly connected to the first magnetic yoke 141, enabling the receiving of a rotational force transmitted by the drive assembly 120.

Another end of the driving shaft 144 passes through the magnetic permeable component 143, the sealing chamber 143a, and the division plate 160 sequentially, and ultimately enters the cleaning chamber 160b, enabling the transmission of a rotational force to a connecting gear set 146 The end of the driving shaft 144 within the cleaning chamber 160b is provided with a drive gear 145, and a rotation of the drive gear drives the connecting gear set 146 in the cleaning chamber 160b.

The connecting gear set 146 may be arranged in a parallel mode or an eccentric mode. Depending on a cutter head structure, the connecting gear set is configured to achieve rotation direction adjustment or multi-head linkage.

A cutting unit 147 is connected to the connecting gear set 146. A rotation of the connecting gear set 146 drives the cutting unit 147 to rotate, thereby completing a shaving operation.

Through a transmission system including the driving shaft 144, the drive gear 145, and the connecting gear set 146, the accurate and efficient transmission from magnetic coupling to head cutting is achieved, which improves the energy conversion efficiency of the system.

The connecting gear set 146 can be designed with a plurality of output gears as needed to support a coordinated operation of a plurality of cutting units 147 (such as a triple-head layout), thereby enhancing shaving coverage and efficiency.

The driving shaft 144 is generally cylindrical. The drive gear 145 is one selected from the group consisting of a spur gear, a helical gear, and other gear types. In this embodiment, a spur gear is employed.

As shown in FIG. 1 to FIG. 9, in this embodiment, a mounting frame 148 is fixedly provided in the cleaning chamber 160b. A bearing seat is provided on the mounting frame 148 to allow stable supporting and rotation for the driving shaft 144, thereby guaranteeing smooth rotation and accurate coaxial alignment.

The connecting gear set 146 is arranged on an axle seat or a support point of the mounting frame 148, and through rotational engagement, the accurate transmission and distribution of a cutter head power can be achieved.

The mounting frame 148 serves as a unified support structure for the driving shaft 144 and the connecting gear set 146 to prevent issues such as poor gear meshing or shaft misalignment caused by loosening or deformation.

As shown in FIG. 1 to FIG. 9, in this embodiment, a mounting shell 121 is provided to serve as a housing structure for the drive assembly 120, and a receiving cavity 121a to accommodate an induction coil 122 is formed inside the mounting shell. The induction coil 122 is fixedly arranged in the receiving cavity 121a inside the mounting shell 121. When energized, the induction coil 122 generates an alternating magnetic field, and the alternating magnetic field can penetrate through the mounting shell 121 and the cutter head base 130 to act on the magnetic component 142 inside the cutter head assembly 140.

A contactless magnetic field coupling relationship is established between the induction coil 122 and the magnetic component 142, causing the magnetic component 142 to generate a torque or a force in the magnetic field.

The magnetic component 142 drives components such as the first magnetic yoke 141 and the driving shaft 144 to rotate, ultimately actuating the cutting unit 147 to allow the movement and cleaning of a cutter head.

Traditional shavers often adopt direct motor drive, which carries the risk of water ingress. In the self-cleaning magnetic levitation shaver 100, the induction coil 122 and the magnetic component 142 are completely isolated physically, and a cutter head is driven through magnetic coupling.

The induction coil 122 is located in the fully-sealed mounting shell 121, which significantly enhances the waterproof rating of the shaver and allows the entire shaver to be washed without concern for electrical short circuits.

The receiving cavity 121a of the mounting shell 121 provides secured arrangement and electromagnetic shielding for the induction coil 122, and can avoid magnetic flux leakage or external interference. A side of the mounting shell 121 that is close to the magnetic component 142 is provided with an opening to facilitate the coupling of a magnetic field of the induction coil 122 with the magnetic component 142, which ensures the effective propagation of the magnetic field along a specific path and improves the magnetic coupling efficiency and power output stability.

The induction coil 122 is generally a magnetic induction coil 122, and a plurality of magnetic induction coils are provided. The plurality of magnetic induction coils 122 are arranged at equal angles circumferentially in the receiving cavity 121a, and the plurality of magnetic induction coils 122 are arranged at equal angles around an axis of the magnetic component 142.

As shown in FIG. 1 to FIG. 9, in this embodiment, a first magnetic permeable surface 111 is provided on a side of the drive base 110 that is close to the cutter head base 130, and a magnetic field can penetrate through the first magnetic permeable surface 111 and reach an exterior of the drive base 110.

A second magnetic permeable surface 131 is provided on a side of the cutter head base 130 that is close to the drive base 110, and a magnetic field can penetrate through the second magnetic permeable surface 131 and reach an interior of the cutter head base 130.

When the induction coil 122 is energized, a magnetic field penetrates through the first magnetic permeable surface 111, the second magnetic permeable surface 131, and the magnetic permeable component 143 sequentially and ultimately acts on the magnetic component 142, and effective magnetic field coupling is achieved at the magnetic component 142, thereby driving a cutter head to rotate.

By establishing a continuous magnetic permeable path (from the first magnetic permeable surface 111 to the second magnetic permeable surface 131 and then to the magnetic permeable component 143), a magnetic field can be transmitted to the magnetic component 142 with a minimal loss. This design can ensure efficient magnetic force output efficiency, reduce the loss and interference of a magnetic field at a structural interface, and improve a drive response speed and a torque strength.

There is no electrical or mechanical connection between the induction coil 122 and the magnetic component 142, and the coupling is achieved entirely through magnetic field penetration, which can avoid moisture ingress.

As shown in FIG. 1 to FIG. 9, in this embodiment, when the induction coil 122 does not work, the magnetic component 142 exerts a magnetic attraction for the second magnetic yoke 123, such that the cutter head base 130 can be attracted and thus arranged on the drive base 110. During disassembly, due to the relatively weak magnetic attraction between the magnetic component 142 and the second magnetic yoke 123, the cutter head base 130 can be easily removed from the drive base 110.

The second magnetic yoke 123 is made of a high-magnetic-permeability material, and is configured to form a closed magnetic circuit to improve magnetic flux utilization efficiency. For example, the high-magnetic-permeability material is a silicon steel material or a soft magnetic iron alloy material. The second magnetic yoke 123 is generally shaped as a circular plate, and the second magnetic yoke 123 is arranged on a back side of the induction coil 122 in the receiving cavity 121a, namely, a side of the induction coil 122 that is away from the cutter head assembly 140. A function of the second magnetic yoke is to guide a magnetic flux, reflect a magnetic flux, or close a magnetic flux loop.

As shown in FIG. 1 to FIG. 9, in this embodiment, a circuit board 180 is arranged in the sealed cavity 110a of the drive assembly 120, and is completely isolated from an external environment (especially moisture), thereby ensuring stable operations of electronic elements of the circuit board.

The circuit board 180 is connected to a power supply 125 to receive a stable power supply from the power supply 125, and is configured to control an operating state of the induction coil 122. The circuit board 180 drives the induction coil 122 to generate an alternating magnetic field by controlling a frequency, a waveform, and an intensity of an output current. The alternating magnetic field acts on the magnetic component 142 of the cutter head assembly 140 through a multi-layered magnetic permeable path to enable contactless rotational drive for the cutting unit 147. The induction coil 122, the circuit board 180, and the power supply 125 are collectively integrated in the sealed chamber 110a to produce a complete closed-loop electromagnetic drive system.

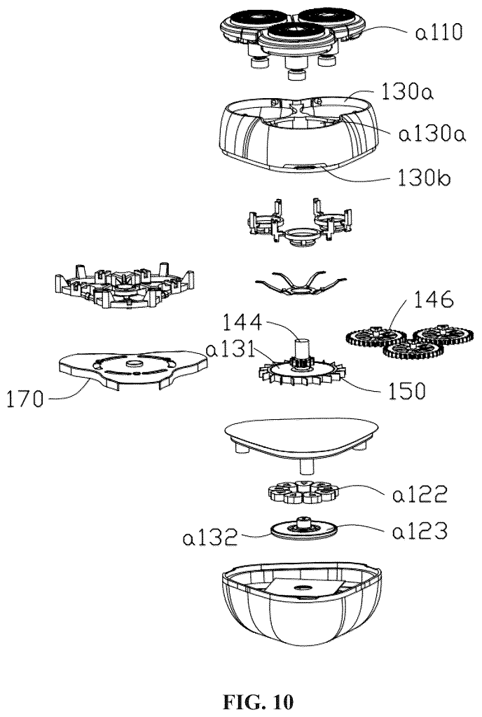

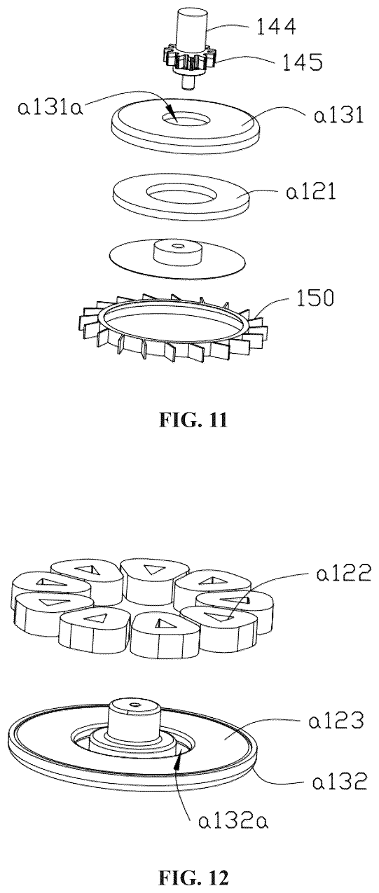

Embodiment 2: As shown in FIG. 10 to FIG. 12, a magnetic focusing structure is additionally provided in the self-cleaning magnetic levitation shaver 100 to avoid low magnetic field utilization efficiency during a magnetic drive process.

During operation, a magnetic field variation component a122 establishes a main magnetic flux in a coupling region through an alternating current, and a concentrating assembly confines and restricts magnetic fluxes generated by a drive magnetic component a121, the magnetic field variation component a122, and an auxiliary magnetic component a123 by forming a high-magnetic-permeability loop. Consequently, effective magnetic fluxes circulate primarily in the accommodating space a130a in a closed manner to apply an axial resultant force to the drive magnetic component a121 in a symmetrical magnetic circuit. In this way, the drive magnetic component a121 is in transmission connection with the cutter head assembly a110 to enable a rotational movement of a cutter head.

The symmetrical arrangement suppresses radial unbalanced forces and provides a centralized magnetic field constraint for the drive magnetic component a121. In combination with magnetic flux confinement and guidance of the concentrating assembly, a low-friction and low-contact quasi-levitation guiding channel is formed. As a result, a mover acquires a stable driving force and travel control, thereby completing the power output required for shaving.

This can significantly improve magnetic coupling efficiency and reduce magnetic leakage and ineffective magnetic fields. Therefore, a high thrust, pulling force, or electromagnetic torque can be achieved with small volume and low power consumption, enabling the overall miniaturization and lightweight design. Magnetic levitation and low-friction support brought by symmetrical magnetic circuits can significantly reduce noise and wear and improve lifespan and shaving cleanliness.

Concentrating magnetic fluxes within the accommodating space a130a can reduce electromagnetic interference with surrounding circuits and metal components and enhance operational safety and reliability. Due to improved magnetic energy utilization efficiency and controllable heat distribution, coil temperature rise and energy consumption are reduced, the shaving endurance performance is prominent, and the overall shaving efficiency is enhanced.

It should be noted that the drive magnetic component a121 is a magnet, the magnetic field variation component a122 is a magnetic induction coil, and the auxiliary magnetic component a123 is a magnet. The magnetic field variation component a122 is located in a coupling region between a first shielding component a131 and a second shielding component a132, and is centrally arranged between opposing faces of the first shielding component a131 and the second shielding component a132. In this way, there is a substantially symmetrical relationship of the magnetic field variation component with first and second accommodating grooves a132a in terms of both an axis and a face clearance. The concentrating assembly includes the first shielding component a131 and the second shielding component a132 that are arranged oppositely. Both the first shielding component and the second shielding component are circular, cover-shaped iron components (for example, formed by machining or stamping from pure iron/low-carbon soft iron).

With the arrangement of the first shielding component a131 and the second shielding component a132 (made of an iron material) and the formation of the first accommodating groove a131a and the second accommodating groove a132a, the drive magnetic component a121 and the auxiliary magnetic component a123 are close to the coupling region of the magnetic field variation component a 122. This solution can reduce the equivalent magnetic gap and increase the magnetic flux density.

The concentrating assembly confines magnetic fluxes in the accommodating space a130a to reduce ineffective magnetic fields and magnetic leakage and enhance an effective electromagnetic force or electromagnetic torque acting on the drive magnetic component a121. Thus, the cutter head assembly a110 can be driven with small volume and low power consumption, which improves shaving power and efficiency.

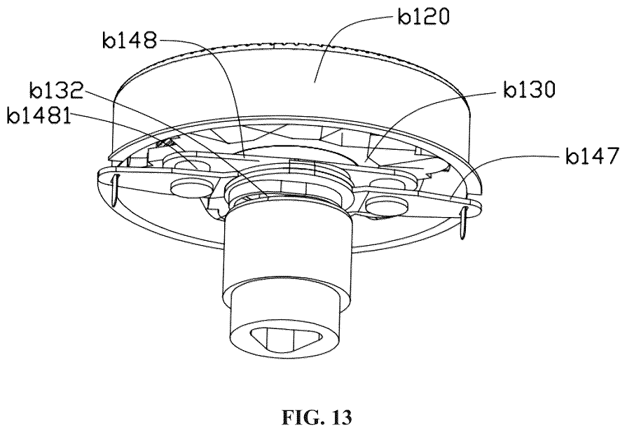

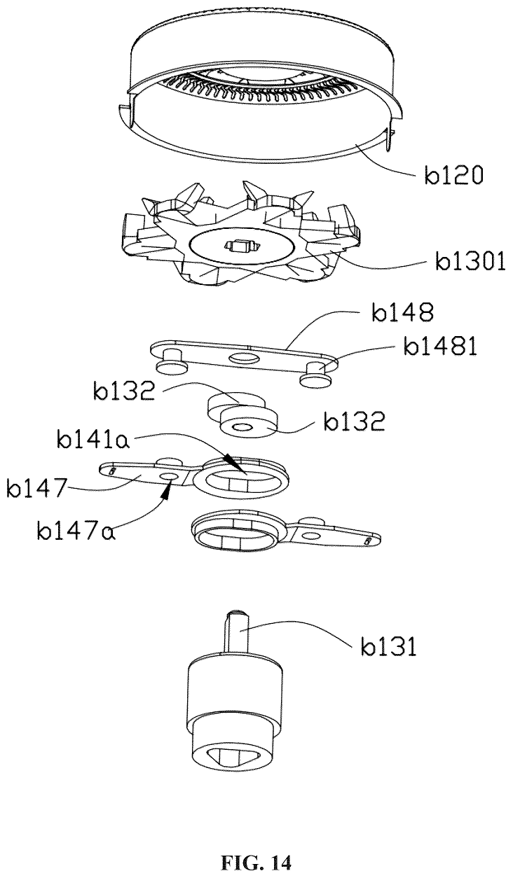

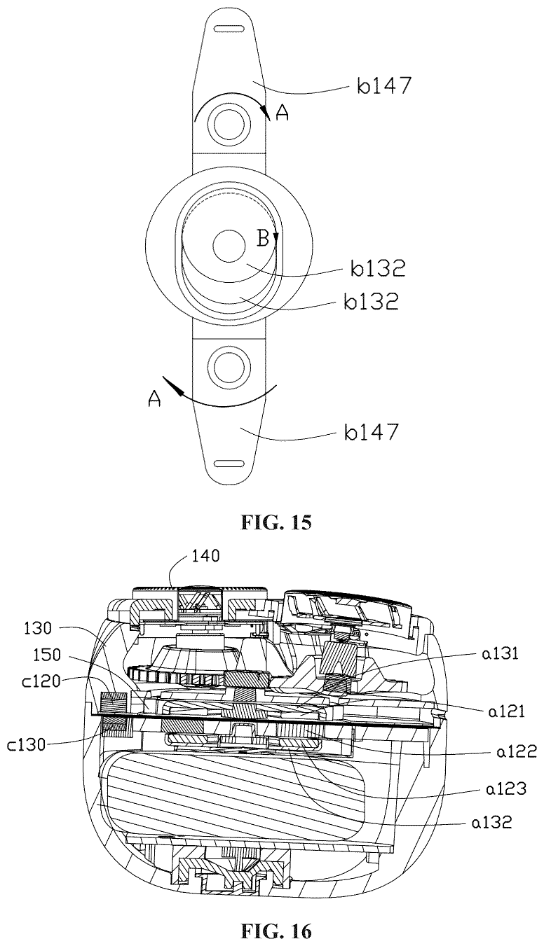

Embodiment 3: As shown in FIG. 13 to FIG. 15, to avoid low beard hair-capturing efficiency of an outer foil b120, an auxiliary reciprocating assembly b140 is provided in the self-cleaning magnetic levitation shaver 100 to actively capture beard hairs. A drive source connected to the auxiliary reciprocating assembly b140 includes, but is not limited to, magnetic drive, motor drive, etc.

When the shaver is turned on by a user, a cutting assembly b130 is driven to move, a movement output by the cutting assembly is transmitted through the auxiliary reciprocating assembly b140 to drive the outer foil b120 to perform a reciprocating oscillation relative to the cutter head base b110. Thus, during shaving, the cutting assembly b130 performs a cutting movement against beard hairs inside the outer foil b120, and the outer foil b120 performs a bidirectional reciprocating oscillation relative to the cutter head base b110. As a result, the outer foil b120 can actively perform a high-frequency reciprocating oscillation under the driving of the cutting assembly b130 to automatically adjust a contact position with the skin.

During an oscillation process, positions and orientations of pores of the outer foil b120 relative to a skin constantly change. Beard hairs that are originally pressed flat against a skin by the outer foil can be lifted and exposed near the pores of the outer foil, and thus increased beard hairs can smoothly enter an interior of the outer foil b120 and be cut by the cutting assembly b130. Consequently, the shaving cleanliness is significantly improved, and residual beard hairs are reduced.

Moreover, during a given shaving period, an oscillation movement of the outer foil b120 and a cutting movement of the cutting assembly b130 act together on a facial region, such that increased beard hairs can be captured and cut with few passes, which improves shaving efficiency.

The superposition of a high-speed cutting movement of a cutter head b1301 and a reciprocating oscillation of the outer foil b120 allows a thorough coverage trajectory of the outer foil b120 in a same skin region within a same shaving duration and the capture of increased beard hairs by a single pass. Additionally, the outer foil b120 continuously alters a contact state with a skin through active oscillations, which facilitates the thorough shaving with few passes and enhances the overall shaving efficiency.

The outer foil b120 is arranged on the cutter head base b110, and is preferably arranged at a front end or a top of the cutter head base b110. The outer foil is configured to directly contact a face of a user during use. The outer foil b120 is provided with a plurality of pores or slits for beard hairs to enter, and the beard hairs entering these pores are cut by the cutter head b1301 in the cutting assembly b130.

The cutting assembly b130 is arranged in a mounting cavity b110a and partially extends into the interior of the outer foil b120. The cutting assembly b130 may include a drive shaft b131, a cutter head b1301, a transmission mechanism configured to transmit a power output by a motor b1322 to the drive shaft b131, etc. The drive shaft b131 and the transmission mechanism are entirely arranged in the mounting cavity b110a of the cutter head base b110. The cutter head b1301 or a portion directly connected to the cutter head b1301 passes through an opening between the cutter head base b110 and the outer foil b120 and partially extends into the interior of the outer foil b120, which allows a relative movement with the outer foil b120 to achieve beard hair cutting.

An end or a portion of the auxiliary reciprocating assembly b140 is fixedly or detachably arranged on the outer foil b120, and can move with the outer foil b120. Another end or another portion of the auxiliary reciprocating assembly b140 is in transmission connection with the cutting assembly b130. It should be noted that the fixed arrangement includes bonding, welding, integral forming, etc., but is not limited thereto, and the detachable arrangement includes screw fastening, plug-in connection, snap-fit, magnetic attachment, etc., but is not limited thereto. The cutter head base b110 is generally a rectangular, elliptical, or cylindrical cutter head base b110. In other embodiments, the cutter head base may be in other shapes.

During shaving, the motor drives the drive shaft b131 to rotate to drive an eccentric wheel b132 arranged on the drive shaft b131 to rotate, and a rotation of the eccentric wheel b132 pushes a peripheral wall of the movement groove b141a to drive a first reciprocating component b147 to perform a high-frequency, small-angle reciprocating oscillation around a rotating column b1481 as an axis. Accordingly, the outer foil b120 is driven to perform a reciprocating oscillation relative to the cutter head base b110. This design improves the efficiency of beard hairs to enter the outer foil b120 and reduce the probability of pressing beard hairs flat by the outer foil b120. A high-frequency, small-angle reciprocating oscillation of the outer foil b120 eliminates the need for a user to repeatedly perform a shaving operation back and forth, thereby improving shaving efficiency and cleanliness.

It should be noted that, in an embodiment, there is one first reciprocating component b147, and the outer foil b120 is driven by the one first reciprocating component b147 to perform a reciprocating oscillation relative to the cutter head base b110.

In another embodiment, there are two first reciprocating components b147. The two first reciprocating components b147 are driven by two eccentric wheels b132 centrosymmetrically arranged to perform a reciprocating oscillation around two respective rotating columns b1481. Ultimately, a high-frequency oscillation of the outer foil b120 relative to the cutter head base b110 is stable.

Specifically, the first reciprocating component b147 includes an elliptical ring portion and a straight plate portion. The elliptical ring portion is provided with a movement groove b141a, and an outer surface of the elliptical ring portion is fixedly connected to an end of the straight plate portion. Additionally, a middle section of the straight plate portion is provided with a through rotation hole b147a. The first reciprocating component b147 includes, but is not limited to, the above shape and structure. A position at which the first reciprocating component b147 is arranged includes, but is not limited to, an end, a middle section, a corner, an inner surface, or an outer surface of the outer foil b120.

A fixation component b148 is generally a rectangular plate, and two ends of the fixation component protrude in an axial direction of the drive shaft b131 to form a cylindrical rotating column b1481. A shape of the fixation component b148 includes, but is not limited to, the aforementioned shape and structure. A middle section of the fixation component b148 is provided with a through hole, and the drive shaft b131 passes through the through hole. A bearing is provided between the drive shaft b131 and the fixation component b148. An arrangement mode and configuration of the fixation component b148 include, but are not limited to the arrangement mode, position, and configuration mentioned above.

The drive shaft b131 is cylindrical. The eccentric wheel b132 is wheel-shaped and is provided with an eccentric hole. The drive shaft b131 passes through the eccentric hole and is fixedly connected to the eccentric wheel b132.

What is claimed is:

1. A self-cleaning magnetic levitation shaver, comprising:
a drive base inside which a sealed cavity is formed;
a drive assembly arranged in the sealed cavity;
a cutter head base inside which an accommodating cavity is formed, wherein the cutter head base is provided with a discharge hole communicating with the accommodating cavity;
a cutter head assembly that is arranged in the accommodating cavity and partially extends out of the accommodating cavity, wherein the cutter head assembly communicates with the accommodating cavity; and
a negative pressure generation component arranged on the cutter head assembly,
wherein when the drive assembly operates, a magnetic field is generated and coupled with the cutter head assembly to drive the cutter head assembly to move to drive a rotation of the negative pressure generation component, whereby a negative pressure is generated to draw external water into the accommodating cavity for cleaning.

2. The self-cleaning magnetic levitation shaver according to claim 1, further comprising:
a division plate that is arranged in the accommodating cavity and divides the accommodating cavity into a negative pressure chamber and a cleaning chamber, wherein the division plate is provided with a via hole, the negative pressure chamber communicates with the cleaning chamber through the via hole, and the negative pressure chamber communicates with the discharge hole;
the cutter head assembly has an end arranged inside the negative pressure chamber and another end extending through the division plate into the cleaning chamber;
the negative pressure generation component is located inside the negative pressure chamber and is arranged surrounding the cutter head assembly; and
when the negative pressure generation component rotates, the negative pressure is generated inside the negative pressure chamber to induce a vortex flow of a cleaning solution in the cleaning chamber to clean the cutter head assembly inside the cleaning chamber.

3. The self-cleaning magnetic levitation shaver according to claim 2, further comprising:
an annular component arranged inside the negative pressure chamber, wherein the annular component, the division plate, and a bottom wall of the accommodating cavity enclose a negative pressure generation chamber and a drainage channel, the annular component is provided with a through hole, and the negative pressure generation chamber communicates with the discharge hole through the through hole and the drainage channel.

4. The self-cleaning magnetic levitation shaver according to claim 3, wherein the cutter head assembly comprises:
a first magnetic yoke arranged in the negative pressure generation chamber, wherein the negative pressure generation component is arranged surrounding an outer peripheral surface of the first magnetic yoke;
a magnetic component arranged on a side of the first magnetic yoke that is close to the drive assembly, wherein the magnetic component is coupled with the drive assembly; and
a magnetic permeable component arranged on a side of the magnetic component that is close to the drive assembly, wherein the magnetic permeable component and the first magnetic yoke enclose a sealing chamber, and the magnetic component is located in the sealing chamber.

5. The self-cleaning magnetic levitation shaver according to claim 4, wherein the cutter head assembly further comprises:
a driving shaft, wherein an end of the driving shaft is rotatably connected to the cutter head base and is located in the negative pressure generation chamber, and another end of the driving shaft passes through the magnetic permeable component, the sealing chamber, and the division plate sequentially and extends into the cleaning chamber;
a drive gear that is arranged on the driving shaft and is located in the cleaning chamber;
a connecting gear set that is arranged in the cleaning chamber and meshes with the drive gear; and
a cutting unit that is arranged in the cleaning chamber and is rotatably connected to the connecting gear set.

6. The self-cleaning magnetic levitation shaver according to claim 5, wherein the cutter head assembly further comprises:
a mounting frame fixed in the cleaning chamber, wherein both the driving shaft and the connecting gear set are rotatably connected to the mounting frame.

7. The self-cleaning magnetic levitation shaver according to claim 4, wherein the drive assembly comprises:
a mounting shell arranged in the sealed cavity, wherein the mounting shell is provided with a receiving cavity; and
an induction coil that is arranged in the receiving cavity and is coupled with the magnetic component.

8. The self-cleaning magnetic levitation shaver according to claim 7, wherein a side of the drive base that is close to the cutter head base has a first magnetic permeable surface;
a side of the cutter head base that is close to the drive base has a second magnetic permeable surface; and
a magnetic field of the induction coil penetrates through the first magnetic permeable surface, the second magnetic permeable surface, and the magnetic permeable component and is coupled with the magnetic component.

9. The self-cleaning magnetic levitation shaver according to claim 7, wherein the drive assembly further comprises:
a second magnetic yoke arranged in the receiving cavity, wherein the second magnetic yoke is located on a side of the induction coil that is away from the cutter head assembly.

10. (canceled)

11. (canceled)

12. The self-cleaning magnetic levitation shaver according to claim 1, further comprising:
a cutting assembly that is arranged inside the cutter head base and partially extends into an outer foil; and
an auxiliary reciprocating assembly that is arranged on the outer foil and is in transmission connection with the cutting assembly,
wherein when the cutting assembly is driven, the outer foil is driven through the auxiliary reciprocating assembly to perform a bidirectional reciprocating oscillation relative to the cutter head base.

13. The self-cleaning magnetic levitation shaver according to claim 12, wherein the auxiliary reciprocating assembly comprises:
a first reciprocating component, wherein the first reciprocating component is provided with a movement groove, an end of the first reciprocating component is detachably connected to the outer foil, and the first reciprocating component is provided with a rotation hole; and
a fixation component provided with a rotating column, wherein the rotating column passes through the rotation hole and the first reciprocating component is rotatably connected to the fixation component; and
the cutting assembly comprises:
a drive shaft that is arranged inside the cutter head base and passes through the fixation component; and
an eccentric wheel that is eccentrically arranged on the drive shaft and extends into the movement groove,
wherein when the drive shaft rotates, the first reciprocating component is driven through the eccentric wheel to perform a reciprocating oscillation around the rotating column as an axis, so as to drive the outer foil to perform a reciprocating oscillation relative to the cutter head base.
